(19) United States
(12) Patent Application Publication
(10) Pub. No.: US 2005/0140236 A1
(43) Pub. Date: Jun. 30, 2005

(54) Rotor structure of multi-layer interior permanent magnet motor

(76) Inventors: Jae Hun Jeong, Gwanginyeong-city (KR); Jong Dae Kim, Seoul (KR); Sang Hyun Jang, Hwaseong-city (KR); Jae Kwang Kim, Seoul (KR)

Correspondence Address: MORGAN, LEWIS & BOCKIUS LLP (SF), 2 PALO ALTO SQUARE, PALO ALTO, CA, 94306, US

(21) Appl. No.: 11/016,237

(22) Filed: Dec. 17, 2004

(30) Foreign Application Priority Data
Dec. 30, 2003 (KR) 10-2003-0100894

(51) Int. Cl. H02K 11/00

(52) U.S. Cl. 310/156.53

(57) ABSTRACT

The rotor structure of a multi-layer interior permanent magnet motor includes at least two insertion cavity groups are formed in an interior of a rotor symmetrically with respect to a rotating axis of the rotor. Each insertion cavity group includes a plurality of pairs of insertion cavities that are adjacently located along a radial direction of the rotor. Among the plurality of pairs of insertion cavities, a center post of an outer pair of insertion cavities is formed to be narrower than a center post of an inner pair of insertion cavities.

### CROSS REFERENCE TO RELATED APPLICATION

This application claims priority to Korean Application No. 10-2003-0100894, filed on Dec. 30, 2003, the disclosure of which is incorporated herein by reference.

### TECHNICAL FIELD

The present invention relates to an interior permanent magnet motor, and more particularly, to a rotor structure of an interior permanent magnet motor having improved structural strength.

### BACKGROUND

Alternating current (AC) motors can be divided generally into AC induction motors and AC synchronous motors. In a revolving field type of AC synchronous motor in which a stator is provided with armature windings and a rotor is provided with magnet windings, the rotor is changed to an electromagnet by excitation of the magnet windings of the rotor, and the rotor rotates by applying a three-phase alternating current to the stator.

An AC synchronous motor in which the electromagnet of the rotor is substituted by a permanent magnet is generally called a permanent magnet motor, and the permanent magnet motor in which a permanent magnet is located in an interior of the rotor is called an interior permanent magnet motor.

Because the multi-layer interior permanent magnet synchronous motor can obtain improved output characteristics in a wide speed range from a low speed to a high speed with a combination of a flux-weakening control technology and can increase torque density to a spatial non-symmetry of inductance, the multi-layer permanent synchronous motor is developed as an integrated starter generator (ISG).

However, when the rotor rotates at a very high speed, a concentration of stress due to centrifugal force or excitation force may occur at a portion of the rotor supporting the permanent magnet. In a structure of a conventional rotor of a multi-layer interior permanent magnet motor, thicknesses of portions of the rotor supporting the magnet are formed to be constant. Therefore, the conventional rotor structure has a disadvantage in that a portion of a rotor supporting a permanent magnet may be destroyed by a concentration of stress.

The information disclosed in this Background of the Invention section is only for enhancement of understanding of the background of the invention and should not be taken as an acknowledgement or any form of suggestion that this information forms the prior art that is already known to a person skilled in the art.

### SUMMARY

The motivation for the present invention is to provide a rotor structure of an interior permanent magnet motor having improved structural strength so that destruction due to centrifugal force can be prevented.

In an exemplary rotor structure of a multi-layer interior permanent magnet motor according to an embodiment of the present invention, at least two insertion cavity groups are formed in an interior of a rotor symmetrically with respect to a rotating axis of the rotor, and each insertion cavity group comprises a plurality of pairs of insertion cavities that are adjacently located along a radial direction of the rotor. Among the plurality of pairs of insertion cavities, a center post of an outer pair of insertion cavities is formed to be narrower than a center post of an inner pair of insertion cavities.

Among the plurality of pairs of insertion cavities, a bridge of an outer pair of insertion cavities may be formed to be narrower than a bridge of an inner pair of insertion cavities.

In another embodiment of the present invention, at least two insertion cavity groups are formed in an interior of a rotor symmetrically with respect to a rotating axis of the rotor, and each insertion cavity group comprises a plurality of pairs of insertion cavities that are adjacently located along a radial direction of the rotor. Among the plurality of pairs of insertion cavities, a bridge of an outer pair of insertion cavities is formed to be narrower than a bridge of an inner pair of insertion cavities.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a rotor structure of a multi-layer interior permanent magnet motor according to an embodiment of the present invention.

### DETAILED DESCRIPTION OF THE EMBODIMENTS

Hereinafter, an embodiment of the present invention will be described in detail with reference to the accompanying drawings.

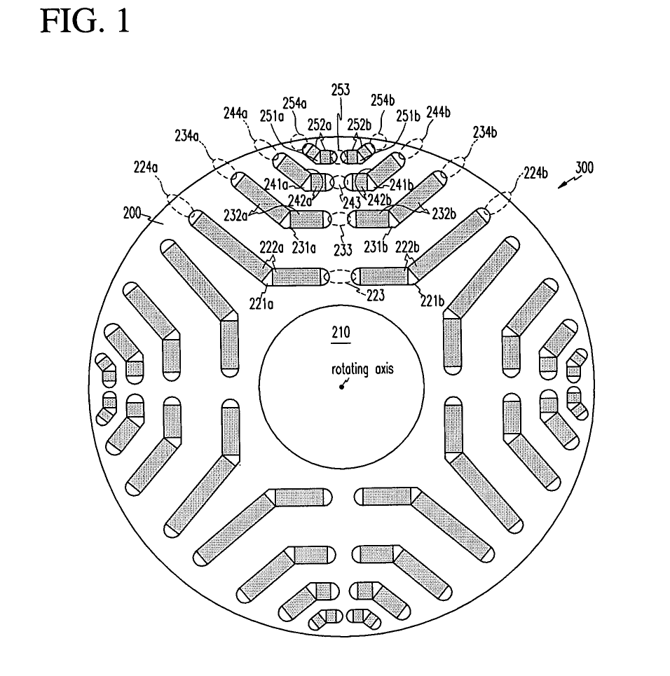

A rotor structure of a multi-layer interior permanent magnet motor according to an embodiment of the present invention is shown in FIG. 1. An insertion hole 210 into which a rotating shaft is inserted is formed at a center portion of a rotor core 200 that may be made of a steel plate. A plurality of insertion cavities are formed in an interior of the rotor core 200. A permanent magnet is located within each insertion cavity.

At least two insertion cavity groups are formed in the rotor core 200, and insertion cavity groups are formed symmetrically with respect to a rotating axis of a rotor 300. Although this embodiment is described for a rotor having four insertion cavity groups, i.e., a four-pole rotor, it can be generalized to other numbers of poles (e.g. 2, 6, etc.). Each insertion cavity group comprises a plurality of pairs of insertion cavities that are adjacently located along a radial direction of the rotor core 200. Each pair of the insertion cavities is generally formed as a V shape.

The insertion cavity group includes a first pair of insertion cavities 221a and 221b, a second pair of insertion cavities 231a and 231b, a third pair of insertion cavities 241a and 241b, and a fourth pair of insertion cavities 251a and 251b.

First permanent magnets 222a and 222b are inserted respectively into the first pair of insertion cavities 221a and 221b, second permanent magnets 232a and 232b are inserted respectively into the second pair of insertion cavities 231a and 231b, third permanent magnets 242a and 242b are inserted respectively into the third pair of insertion cavities 241a and 241b, and fourth permanent magnets 252a and 252b are inserted respectively into the fourth pair of insertion cavities 251a and 251b.

The size of the permanent magnets is gradually decreased as moving farther from the insertion hole 210. That is, an inner permanent magnet size is greater than an outer permanent magnet size. When the rotor core 200 rotates with respect to its rotating axis, stress due to centrifugal force and excitation force of the permanent magnet occurs in the rotor core 200.

The stress is generally concentrated on center posts 223, 233, 243, and 253 and bridges 224a, 234a, 244a, 254a, 224b, 234b, 244b, and 254b of the pair of the insertion cavities, and stress occurring in the center posts and the bridges increases as the size of the inserted permanent magnet. Therefore, the center post 223 and the bridges 224a and 224b of the first pair of insertion cavities 221a and 221b are formed to be wider respectively than the center post 233 and the bridges 234a and 234b of the second pair of insertion cavities 231a and 231b.

In addition, the center post 243 and the bridges 244a and 244b of the third pair of insertion cavities 241a and 241b and the center post 153 and the bridges 254a and 254b of the fourth pair of insertion cavities 251a and 251b become gradually narrower. That is, bridges of an outer pair of insertion cavities are formed to be narrower than bridges of an inner pair of insertion cavities, in response to a decrease of the size of the inserted permanent magnet.

Consequently, according to an embodiment of the present invention, destruction of the center posts and the bridges due to a concentration of stress can be avoided, so that overall structural strength of the rotor is increased.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A rotor structure of a multi-layer interior permanent magnet motor, wherein at least two insertion cavity groups are formed in an interior of a rotor symmetrically with respect to a rotating axis of the rotor, and each insertion cavity group comprises a plurality of pairs of insertion cavities that are adjacently located along a radial direction of the rotor, and wherein among the plurality of pairs of insertion cavities, a center post of an outer pair of insertion cavities is formed to be narrower than a center post of an inner pair of insertion cavities.

2. The rotor structure of claim 1, wherein among the plurality of pairs of insertion cavities, a bridge of an outer pair of insertion cavities is formed to be narrower than a bridge of an inner pair of insertion cavities.

3. A rotor structure of a multi-layer interior permanent magnet motor, wherein at least two insertion cavity groups are formed in an interior of a rotor symmetrically with respect to a rotating axis of the rotor, and each insertion cavity group comprises a plurality of pairs of insertion cavities that are adjacently located along a radial direction of the rotor, and wherein among the plurality of pairs of insertion cavities, a bridge of an outer pair of insertion cavities is formed to be narrower than a bridge of an inner pair of insertion cavities.

4. The rotor structure of claim 3, wherein among the plurality of pairs of insertion cavities, a center post of an outer pair of insertion cavities is formed to be narrower than a center post of an inner pair of insertion cavities.

5. A rotor structure of a multi-layer interior permanent magnet motor, comprising a rotor defining at least two insertion cavity groups arranged symmetrically about a rotating axis of the rotor, wherein each insertion cavity group comprises a pair of adjacent insertion cavities separated by a center post, where the further the center post from said rotating axis, the narrower the center post.

6. The rotor structure of claim 5, wherein each insertion cavity is separated from an exterior of said rotor by a bridge, where a bridge of an outer pair of insertion cavities is formed to be narrower than a bridge of an inner pair of insertion cavities.

7. A rotor structure of a multi-layer interior permanent magnet motor, comprising a rotor defining at least two insertion cavity groups arranged symmetrically about a rotating axis of the rotor, wherein each insertion cavity group comprises a pair of adjacent insertion cavities each separated from an exterior of said rotor by a bridge, where a bridge of an outer pair of insertion cavities is formed to be narrower than a bridge of an inner pair of insertion cavities.

8. The rotor structure of claim 7, wherein said pair of adjacent insertion cavities is separated by a center post, where the further the center post from said rotating axis, the narrower the center post.
